(19) United States
(12) Patent Application Publication
(10) Pub. No.: US 2020/0141491 A1
(43) Pub. Date: May 7, 2020

(54) OIL SCRAPER PISTON RING

(71) Applicant: Federal-Mogul Burscheid GmbH, Burscheid (DE)

(72) Inventors: Peter SCHMIDT, Burscheid (DE); Sabine BALKE, Burscheid (DE)

(21) Appl. No.: 16/619,285

(22) PCT Filed: May 17, 2018
(86) PCT No.: PCT/DE2018/100471

§ 371 Date: Dec. 4, 2019

(30) Foreign Application Priority Data
Jun. 19, 2017 (DE) 10 2017 113 354.2

(51) Int. Cl. F16J 9/20; F16J 9/14

(52) U.S. Cl. CPC F16J 9/206; F16J 9/26; F16J 9/14

(57) ABSTRACT

An oil scraper piston ring which includes a running face region formed by at least two running face lands, an inner circumferential surface, and upper and lower flank surfaces extending between the running face region and the inner circumferential surface, also includes a joint and oil passage openings extending radially between the running face lands from the outside to the inside, optionally operatively connected to a spring element, wherein the joint is formed by at least two spaced slotted regions having a predefinable shape and dimensions, which are not directly connected to one another, so that each slotted region formed by a slot extends, proceeding from the associated flank surface, at least into one oil passage opening provided between at least two running face lands.

### BACKGROUND OF THE INVENTION

The invention relates to an oil scraper piston ring.

DE 10 2007 059 205 B4 discloses an oil scraper ring, comprising a base body that is provided with a joint opening and that, on the inner circumferential surface thereof, cooperates with a spring element and includes oil discharge channels extending in the radial direction, wherein, proceeding from the respective end face of the joint opening, slots having a predefinable length that extend in the circumferential direction are introduced in the region of the outer circumferential surface of the base body, which are provided to retain and/or guide the end regions of a sealing element extending across the joint opening.

Presently, oil scraper piston rings are used which have a rectilinearly extending joint. The oil scraper piston ring is able to scrape the oil very well by way of the running face lands thereof, but leaves a larger amount of oil behind in the region of the joint, which remains on the cylinder. The oil cannot be fully distributed or picked up by the compression rings provided above the oil scraper piston ring, and thus remains on the cylinder, or is even thrown onto the piston. This may cause residual oil to be carried into the combustion chamber and
the oil consumption to be increased,
(particulate) emissions to be increased, and
uncontrolled combustion or knocking to occur in gas engines.

### SUMMARY OF THE INVENTION

It is the object of the invention to provide an oil scraper piston ring that has an alternative design with respect to the joint region so as to account for the highlighted problems, so that an oil-tight joint can be achieved without additional sealing elements in the joint region.

This object is achieved by an oil scraper piston ring, comprising a running face region formed by at least two running face lands, an inner circumferential surface, and upper and lower flank surfaces extending between the running face region and the inner circumferential surface, furthermore comprising a joint and oil passage openings extending radially between the running face lands from the outside to the inside, optionally operatively connected to a spring element, wherein the joint is formed by at least two spaced slotted regions having a predefinable shape and dimensions, which are not directly connected to one another, so that each slotted region formed by a slot extends, proceeding from the associated flank surface, at least into an oil passage opening provided between at least two running face lands.

The respective slotted regions are generally formed by rectilinearly extending slots having a predefinable axial height and width.

According to one embodiment of the subject matter of the invention, each slotted region extends, proceeding from the associated flank surface, at least into an oil passage opening provided between at least two running face lands.

If necessary, the slotted regions may extend parallel to one another.

In the creation of the design of the oil scraper piston ring according to the invention, it may be useful for the slotted regions to extend at an angle of 90°, proceeding from the respective flank surface, in the direction of the associated oil passage opening.

As an alternative, there is also the option of the slotted regions extending at an angle<90°, and in particular 45°, proceeding from the respective flank surface, in the direction of the associated oil passage opening.

According to another embodiment, the slotted regions extend at differing angles, proceeding from the respective flank surface, in the direction of the associated oil passage opening.

According to a further aspect of the invention, the base body of the oil scraper piston ring according to the invention is made of cast iron or steel.

As has already been described, the slotted regions of a cast iron or steel ring may extend, proceeding from the respective flank surface, into an associated oil passage opening, wherein, as an alternative, it is also possible for the slotted regions to end at a predefinable axial height, proceeding from the respective flank surface, in the material of the cast iron or steel base body.

The axial length of the respective slotted region is not greater than approximately 50% of the axial height of the base body.

As a result of the subject matter of the invention, an oil scraper piston ring is formed, which is configured with an overlap in the region of the joint and thus counteracts the problems that have been described, achieving a similar joint.

Advantages of the subject matter of the invention are:
reduction in the oil consumption
reduction in the (particulate) emissions
reduction in uncontrolled or knocking combustion processes
easy introduction into production.

### BRIEF DESCRIPTION OF THE DRAWINGS

The subject matter of the invention is shown in the drawings based on an exemplary embodiment and is described as follows. In the drawings:

FIGS. 1 to 3 show different designs of oil-tight joint regions on an oil scraper piston ring.

### DETAILED DESCRIPTION OF THE INVENTION

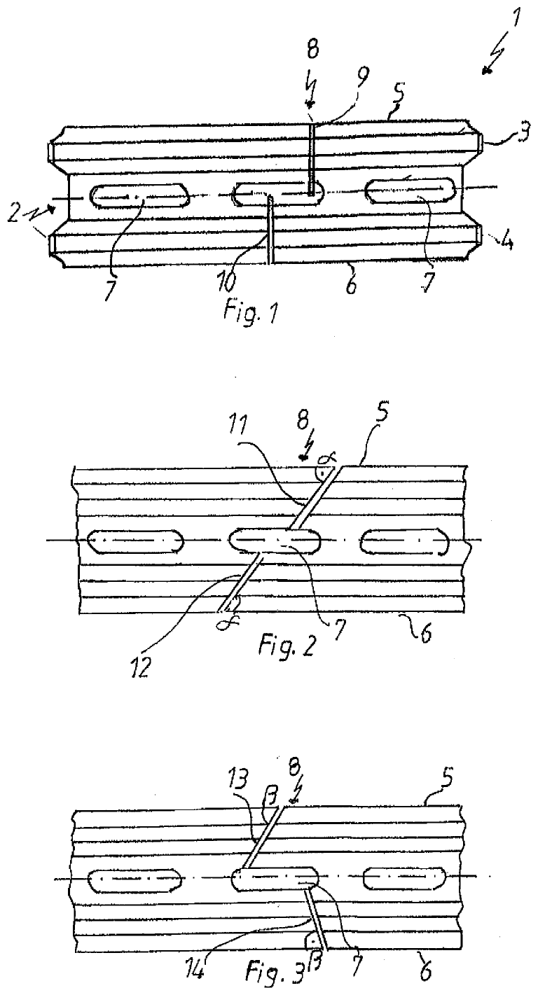

FIG. 1 shows an oil scraper piston ring 1, comprising a running face region 2 in the present example, formed by two running face lands 3, 4. An upper flank surface 5 and a lower flank surface 6 are apparent, as are oil passage openings 7 extending axially between the running face lands 3, 4. Moreover, a joint 8 is apparent.

According to FIG. 1, the joint 8 is formed by a slotted region formed of two slots 9, 10, wherein the slots 9, 10 in the present example, proceeding from the respective flank surface 5, 6, extend axially in the direction of an individual oil passage opening 7, in a manner parallel to one another Δn overlapping region, which forms an oil-tight joint, is thus generated between the running face lands 3, 4 by the slots 9, 10 forming the slotted region.

FIGS. 2 and 3 show alternative embodiments of the joint 8 according to FIG. 1.

According to FIG. 2, two slots 11, 12, which likewise extend parallel to one another, are provided as slotted regions, which, however, deviating from FIG. 1, extend at a predefinable angle α<90°, proceeding from the respective flank surface 5, 6, in the direction of the associated oil passage opening 7.

FIG. 3 shows a further alternative.

In FIG. 3, deviating from FIG. 2, the slots 13, 14 forming the joint 8 extend at differing angles of inclination β, proceeding from the respective flank surface 5, 6, in the direction of the associated oil passage opening 7.

1. An oil scraper piston ring, comprising a running face region formed by at least two running face lands which are parallel to one another, an inner circumferential surface, and upper and lower flank surfaces extending between the running face region and the inner circumferential surface, and further comprising a joint and oil passage openings extending radially from a surface of the oil scraper piston ring between the running face lands to an interior of the oil scraper piston ring, wherein the joint is formed by at least two spaced slotted regions which are not directly connected to one another, so that each slotted region formed by a respective slot extends from a respective one of the flank surfaces at least into one of the oil passage openings provided between the at least two running face lands.

2. The oil scraper piston ring according to claim 1, wherein the slotted regions extend parallel to one another.

3. The oil scraper piston ring according to claim 1, wherein the slotted regions extend at an angle of 90° with respect to the flank surfaces.

4. The oil scraper piston ring according to claim 1, wherein the slotted regions extend at an angle α<90° with respect to the flank surfaces.

5. The oil scraper piston ring according to claim 1, wherein the slotted regions extend at respective different angles β with respect to the flank surfaces.

6. The oil scraper piston ring according to claim 1 made of cast iron or steel.

7. (canceled)

8. (canceled)

9. The oil scraper piston ring according to claim 1, wherein axial length of the slotted region is not greater than approximately 50% of axial height of the oil scraper piston ring.

10. The oil scraper piston ring according to claim 1, wherein the slotted regions extend at an angle α of 45° with respect to the flank surfaces.
